(19) United States
(12) Patent Application Publication
(10) Pub. No.: US 2011/0092237 A1
(43) Pub. Date: Apr. 21, 2011

(54) WIRELESS COMMUNICATION SYSTEM, MANAGEMENT SERVER, MOBILE BASE STATION APPARATUS AND MOBILE BASE STATION CONTROL METHOD

(76) Inventors: Tetsuya Kato, Tokyo (JP); Masahiko Yahagi, Tokyo (JP)

(21) Appl. No.: 12/997,320

(22) PCT Filed: Jun. 5, 2009
(86) PCT No.: PCT/JP2009/060312

§ 371 Date: Dec. 10, 2010

(30) Foreign Application Priority Data
Jul. 17, 2008 (JP) 2008186147

(51) Int. Cl. H04B 7/00

(52) U.S. Cl. 455/507

(57) ABSTRACT

A wireless communication system includes a mobile base station apparatus connecting to a terminal apparatus and being movable, and a management server performing centralized control of the mobile base station apparatus. The mobile base station apparatus measures its position and notifies the management server of position information indicating the position. The management server transmits control information according to the position information notified from the mobile base station apparatus, to the mobile base station apparatus. The mobile base station apparatus operates using the control information received from the management server.

### TECHNICAL FIELD

The present invention relates to a wireless communication system provided with a movable base station apparatus.

### BACKGROUND ART

For a wireless communication system covering a communication area with multiple cells formed by wireless base stations to enable communication by terminals within the communication area, movable wireless base stations (mobile base station apparatuses) may be used in addition to fixedly installed wireless base stations (fixed base station apparatuses). For example, WiMAX (Worldwide Interoperability for Microwave Access) is a wireless communication system of this kind.

For example, mobile base station apparatuses are mounted on mobile bodies which move on a predetermined track, such as a railroad vehicle, or mounted on mobile bodies which move on a route limited to some extent though not on a predetermined track, such as a route bus, an airplane and a ship. The mobile base station apparatuses may be mounted on a sightseeing bus and the like whose route is not limited. Patent Literature 1 discloses a configuration in which terminals in a vehicle are accommodated by a mobile base station apparatus installed in the vehicle.

By installing a mobile base station in a mobile body which moves fast, such as a bus, a train, a ship and an airplane, it is possible to stably connect communication by a terminal in the mobile body. By installing a mobile base station in such a large-sized mobile body in which the number of terminals geographically and temporally fluctuates as the mobile body moves, like a train, a ship and an airplane, it is possible to efficiently assign wireless resources according to the fluctuations in the number of terminals.

Among mobile bodies mounted with a mobile base station apparatus, there are mobile bodies that do not move while the mobile base station apparatus is installed, though temporarily, in addition to mobile bodies that move during operation of the mobile base station apparatus. For example, by installing a mobile base station apparatus in an area where the traffic temporarily suddenly increases, like a disaster area and an event site, it is possible to quickly respond to an increase in traffic.

By utilizing a mobile base station apparatus as described above, it is possible to improve the use efficiency of wireless resources and improve convenience for users. It is desirable to appropriately operate each of such mobile base station apparatuses according to its located position. In Patent Literature 2, it is described that operation control information (parameters) is obtained on the basis of the position of a mobile base station apparatus.

### CITATION LIST

### Patent Literature

### Patent Literature 1: JP2002-335573A

### Patent Literature 2: JP2003-018073A

### SUMMARY OF INVENTION

### Technical Problem

As described above, the mobile base station apparatus itself obtains parameters on the basis of its position in the description of Patent Literature 2. However, there are some parameters for which an appropriate value is determined according to the surrounding environment including backbone facilities and relationships with fixed base station apparatuses and other mobile base station apparatuses. For example, appropriate parameters may change due to a change in the surrounding environment though the mobile base station apparatus itself does not move. Therefore, in the configuration in which each mobile base station apparatus determines operation parameters according to its position, there is a possibility that appropriate operation parameters will not be selected.

An object of the present invention is to provide a technique for appropriately operating a mobile base station apparatus according to its position.

### Solution to Problem

In order to achieve the above object, a wireless communication system according to one aspect of the present invention includes:

a mobile base station apparatus connecting to a terminal apparatus and being movable; and

a management server performing centralized control of the mobile base station apparatus; wherein

the mobile base station apparatus measures its position and notifies the management server of position information indicating the position;

the management server transmits control information according to the position information notified from the mobile base station apparatus, to the mobile base station apparatus; and

the mobile base station apparatus operates using the control information received from the management server.

A management server according to one aspect of the present invention includes:

base station position management means for obtaining position information indicating the position of a mobile base station apparatus connecting to a terminal apparatus and being movable, from the mobile base station apparatus; and

base station control means for transmitting control information according to the position information managed by the base station position management means, to the mobile base station apparatus.

A mobile base station apparatus of the present invention is a mobile base station apparatus connecting to a terminal apparatus and being movable, the mobile base station apparatus including:

position measurement means for measuring the position of the mobile base station apparatus;

notification means for notifying a management server of position information indicating the position measured by the position measurement means; and

operation control means operating by using control information according to the position information, which is received from the management server.

In the mobile base station control method of the present invention, position information indicating the position of a mobile base station apparatus connecting to a terminal apparatus and being movable is obtained from the mobile base station apparatus; and control information according to the obtained position information is transmitted to the mobile base station apparatus.

### BRIEF DESCRIPTION OF DRAWINGS

FIG. 1 is a system configuration diagram showing a wireless communication system of this exemplary embodiment.

FIG. 2 is a block diagram showing the configuration of mobile base station apparatus 11 of this exemplary embodiment.

FIG. 3 is a block diagram showing the configuration of management server 12 of this exemplary embodiment.

FIG. 4 is a flowchart showing the operation of base station control section 32 in the case where control information according to a predicted movement destination is transmitted, and an applying the control information is instructed when movement is actually performed.

FIG. 5 is a diagram showing an application example of the wireless communication system of this exemplary embodiment.

FIG. 6 is a diagram showing another application example of the wireless communication system of this exemplary embodiment.

FIG. 7 is a sequence diagram showing an operation example of the wireless communication system of this exemplary embodiment.

FIG. 8A is a diagram showing an example of a management table on management server 12.

FIG. 8B is a diagram showing an example of the management table on management server 12.

FIG. 8C is a diagram showing an example of the management table on management server 12.

### DESCRIPTION OF EMBODIMENTS

An exemplary embodiment will be described in detail with reference to the drawings.

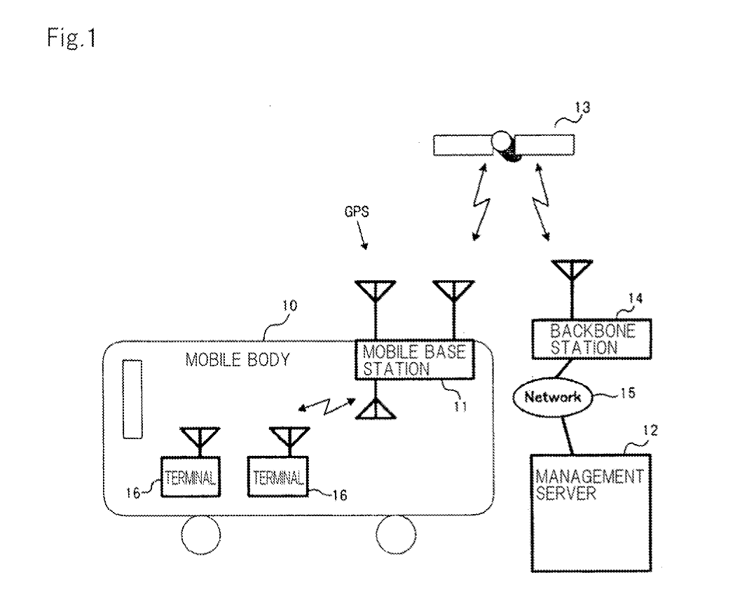

FIG. 1 is a system configuration diagram showing a wireless communication system of this exemplary embodiment. Referring to FIG. 1, the wireless communication system includes mobile base station apparatus 11 and management server 12.

Mobile base station apparatus 11 is installed in mobile body 10 and connected to network 15 via a backbone circuit. In FIG. 1, a backbone circuit constituted by satellite circuit 13 and backbone station 14 is shown as an example. The backbone circuit is not limited to this example, and any circuit is possible if mobile body 10 is enabled to move. Other examples include roaming to another carrier, a microwave circuit, a mobile phone circuit, railroad radio, airplane radio, fire-fighting/police radio and the like.

In an example of a so-called moving network, mobile base station apparatus 11 installed in mobile body 10, such as a train, a bus and a ship, and constituting a mobile cell in mobile body 10 connects to a fixed base station apparatus (not shown) which is fixedly installed outside mobile body 10 as a backbone circuit. In this case, when mobile base station apparatus 11 moves, the connection-destination fixed base station apparatus of mobile base station apparatus 11 is switched. It is preferable that communication between the fixed base station apparatus and mobile base station apparatus 11 is preferentially processed prior to communication performed by direct connection by the fixed base station apparatus and a terminal apparatus.

Management server 12 is also connected to network 15.

Mobile base station apparatus 11 measures its position, for example, using a GPS (Global Positioning System) and notifies management server 12 of position information indicating the position via network 15. Though the GPS is shown as an example here, the position measurement method is not especially limited. As another example, a method in which a beacon is received may be used. Mobile base station apparatus 11 may notify management server 12 of the position information when its position crosses a predetermined area boundary or may periodically notify management server 12 of the position information at predetermined time intervals.

Since control information is sent to mobile base station apparatus 11 from management server 12, mobile base station apparatus 11 operates using the control information. The control information is information specifying the operation of mobile base station apparatus 11, and it is, for example, parameter values that are used to operate mobile base station apparatus 11. Mobile base station apparatus 11 sets the received parameter values for itself and applies them to the operation of its hardware or software. The control information may be information not only to be applied to mobile base station apparatus 11 itself but also to be applied or notified to a terminal apparatus 16 connected to mobile base station apparatus 11.

Management server 12 transmits control information according to the position shown in position information notified from mobile base station apparatus 11, to mobile base station apparatus 11 via network 15. In an example in which the control information is the parameters described above, the parameters are selected according to the geographical position of mobile base station apparatus 11, the characteristics and traffic conditions of the area where mobile base station apparatus 11 exists, relationships with fixed base station apparatuses (not shown) around mobile base station apparatus 11, an available backbone circuit and the like. There may be a parameter which is selected according to the movement speed calculated with the use of positions shown in position information notified in the past.

Parameters and the like used for nearby base station apparatuses (including mobile base station apparatuses and fixed base station apparatuses) may change as mobile base station apparatus 11 moves. In this case, management server 12 may determine control information about the nearby base station apparatuses around mobile base station apparatus 11 according to the position shown in position information notified from mobile base station apparatus 11 and transmit the control information to the nearby base station apparatuses.

As described above, according to this exemplary embodiment, since management server 12 which performs centralized control of mobile base station apparatus 11 determines control information according to position information about mobile base station apparatus 11, and mobile base station apparatus 11 operates using the control information determined by management server 12, it is possible to appropriately operate mobile base station apparatus 11 according to its position.

The wireless communication system of this exemplary embodiment may be such that management server 12 predicts future movement of mobile base station apparatus 11 and transmits control information according to a predicted movement destination. For example, management server 12 may predict the future movement of mobile base station apparatus 11 from a history of position information notified from mobile base station apparatus 11 and transmit control information according to a predicted movement destination to mobile base station apparatus 11. Thereby, even if mobile base station apparatus 11 moves at a high speed, it is possible to quickly follow the movement and control the operation of mobile base station apparatus 11. Management server 12 holds track information indicating the track of mobile base station apparatus 11 in advance and can predict movement of mobile base station apparatus 11 using the track information.

Furthermore, it is also possible for management server 12 to, when mobile base station apparatus 11 moves to the movement destination as predicted after management server 12 transmits the control information according to the predicted movement destination to mobile base station apparatus 11, instruct mobile base station apparatus 11 to apply the control information. When receiving the control information from management server 12, mobile base station apparatus 11 can hold the control information once and apply the control information when management server 12 instructs that the control information be applied. Thereby, it is possible to quickly follow the movement of mobile base station apparatus 11 and certainly cause mobile base station apparatus 11 to apply control information corresponding to the actual movement destination.

Alternatively, it is also conceivable that management server 12 transmits the control information according to the predicted movement destination to mobile base station apparatus 11, and mobile base station apparatus 11 applies the control information when it moves to the movement destination predicted by management server 12. In this case, management server 12 transmits the control information according to the predicted movement destination to mobile base station apparatus 11 together with movement destination information indicating the movement destination. When receiving the control information and the movement destination information from management server 12, mobile base station apparatus 11 applies the control information when it moves to the movement destination shown in the movement destination information. Thereby, it is also possible to quickly follow the movement of mobile base station apparatus 11 and certainly cause mobile base station apparatus 11 to apply control information corresponding to the actual movement destination.

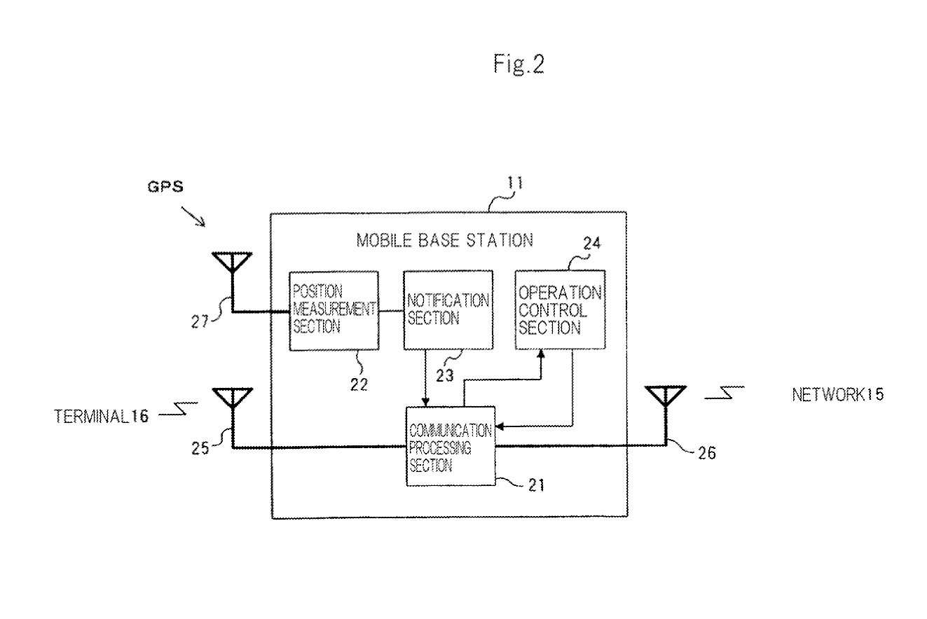

FIG. 2 is a block diagram showing the configuration of mobile base station apparatus 11 of this exemplary embodiment. Referring to FIG. 2, mobile base station apparatus 11 includes communication processing section 21, position measurement section 22, notification section 23 and operation control section 24.

Mobile base station apparatus 11 is a movable wireless base station apparatus, and it wirelessly connects to terminal apparatus 16 and relays communication between terminal apparatus 16 and network 15. Communication processing section 21 connects to terminal apparatus 16 with antenna 25 and connects to a backbone circuit for connecting network 15, using antenna 26, to perform a process for communication between terminal apparatus 16 and network 15. This process includes control for connecting a call and transfer of user data.

Position measurement section 22 measures its position by receiving a GPS signal from a GPS satellite (not shown) with antenna 27.

Notification section 23 notifies management server 12 of position information indicating the position measured by position measurement section 22 from communication processing section 21 via network 15.

Operation control section 24 receives control information from management server 12 via communication processing section 21 and controls the operation of communication processing section 21 in accordance with the control information.

In the case where the control information is transmitted from management server 12 to mobile base station apparatus 11 on the basis of prediction of a movement destination prior to actual movement, operation control section 24 may hold the control information received from management server 12 once and apply it when application is instructed by management server 12.

Alternatively, in the case where the control information according to the predicted movement destination and movement destination information indicating the movement destination are transmitted from management server 12, mobile base station apparatus 11 which receives the control information may apply it when it moves to the movement destination shown in the movement destination information.

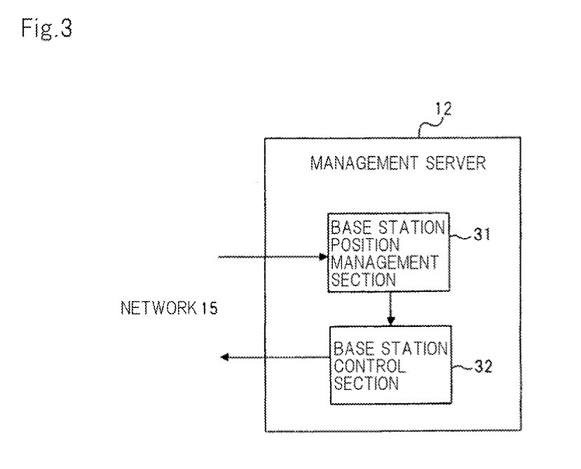

FIG. 3 is a block diagram showing the configuration of management server 12 of this exemplary embodiment. Referring to FIG. 3, management server 12 includes base station position management section 31 and a base station control section 32.

Base station position management section 31 receives position information from each mobile base station apparatus 11 via network 15 and manages the position of each mobile base station apparatus 11 shown in the position information.

Base station control section 32 determines control information to be used for each mobile base station apparatus 11 according to the position of each mobile base station apparatus 11 obtained by base station position management section 31, and transmits the control information to each mobile base station apparatus 11 via network 15. As a concrete example, base station control section 32 can transmit parameter values according to the area where mobile base station apparatus 11 exists, to mobile base station apparatus 11 as control information. For example, base station control section 32 may store an area ID indicating each area and operation parameter values used in the area in a table in association with each other and transmit operation parameter values corresponding to the area to which the position shown in position information received from mobile base station apparatus 11 belongs, to mobile base station apparatus 11 as control information.

Base station control section 32 may predict the future movement of mobile base station apparatus 11 from position information and transmit control information according to a predicted movement destination prior to actual movement of mobile base station apparatus 11. In this case, base station control section 32 may transmit the control information according to the predicted movement destination to mobile base station apparatus 11 together with movement destination information indicating the movement destination.

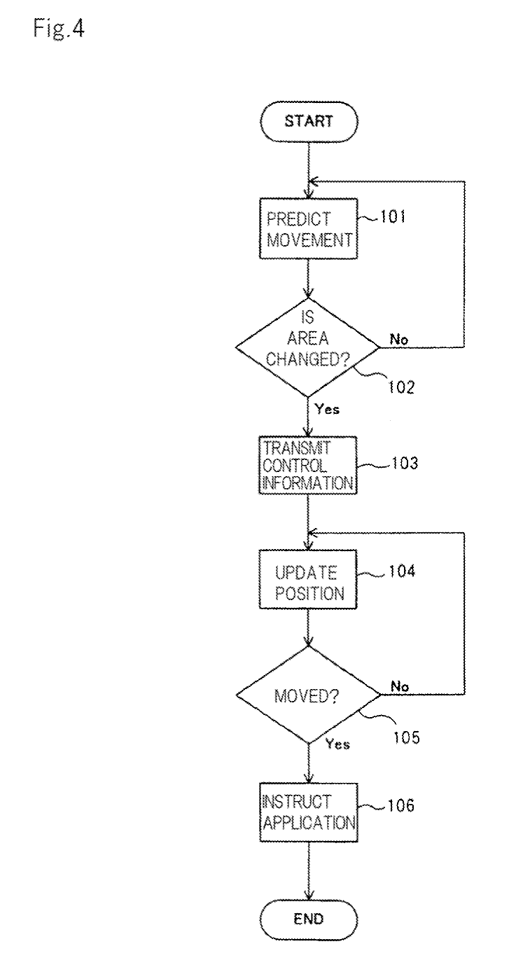

Alternatively, it is also possible for base station control section 32 to, when mobile base station apparatus 11 moves to the movement destination as predicted after base station control section 32 transmits the control information according to the predicted movement destination to mobile base station apparatus 11, instruct mobile base station apparatus 11 to apply the control information. FIG. 4 is a flowchart showing the operation of base station control section 32 in the case where control information according to a predicted movement destination is transmitted, and instruction to apply the control information is issued when movement is actually performed.

Referring to FIG. 4, base station control section 32 predicts movement of mobile base station apparatus 11 on the basis of the position shown in position information notified from mobile base station apparatus 11 first (step 101). Next, base station control section 32 judges whether or not a predicted movement position of mobile base station apparatus 11 is in an area different from the area where mobile base station apparatus 11 is currently present (step 102). If the predicted movement destination position is not in an area different from the area where mobile base station apparatus 11 is currently present, base station control section 32 returns to step 101.

If the predicted movement destination position is in an area different from the area where mobile base station apparatus 11 is currently present, base station control section 32 transmits control information corresponding to the predicted movement destination to mobile base station apparatus 11 (step 103).

Then, base station control section 32 updates the position of mobile base station apparatus 11 in accordance with the position information notified from mobile base station apparatus 11 (step 104). Next, base station control section 32 judges whether or not mobile base station apparatus 11 has moved to the movement destination area as predicted (step 105). If mobile base station apparatus 11 has not moved to the movement destination area as predicted, base station control section 32 returns to step 104.

If mobile base station apparatus 11 has moved to the movement destination area as predicted, base station control section 32 instructs mobile base station apparatus 11 to apply the control information transmitted at step 103 (step 106).

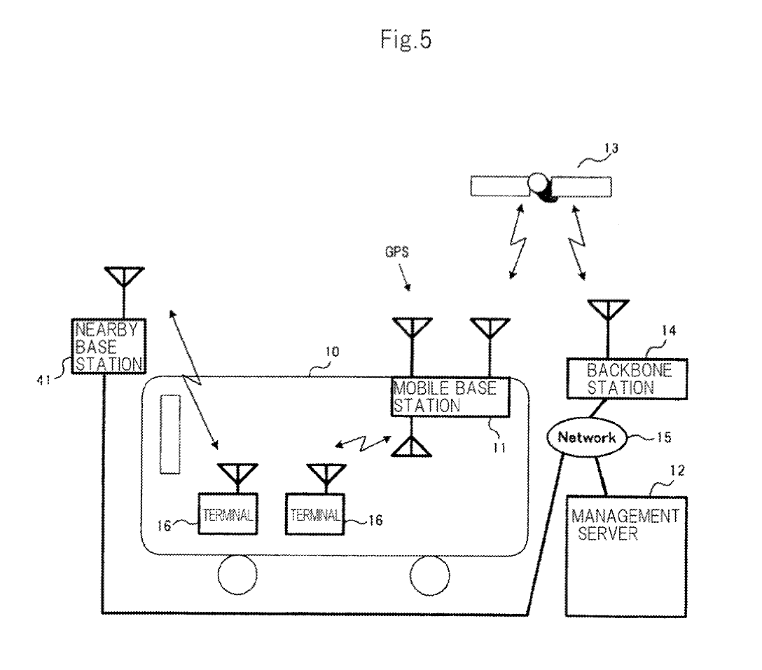

FIG. 5 is a diagram showing an application example of the wireless communication system of this exemplary embodiment. This is a configuration example in which mobile base station apparatus 11 connects terminal apparatus 16 in mobile body 10. However, mobile body 10 is not shielded, and terminal apparatus 16 in mobile body 10 can connect not only to mobile base station apparatus 11 but also to nearby base station apparatus 41 outside mobile body 10. The load that terminal apparatuses 16 place on mobile body 10 can be distributed to mobile base station apparatus 11 and nearby base station apparatus 41.

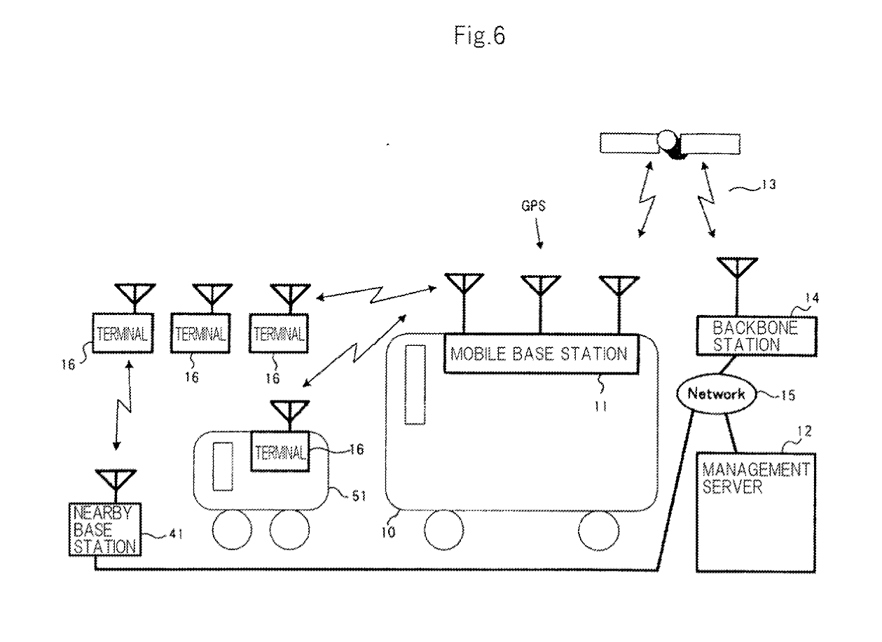

FIG. 6 is a diagram showing another application example of the wireless communication system of this exemplary embodiment. This is a configuration example in which mobile base station apparatus 11 connects terminal apparatus 16 outside mobile body 10. Terminal apparatuses 16 outside mobile body 10 can connect to either mobile base station apparatus 11 or nearby base station apparatus 41. The load by terminal apparatuses 16 can be distributed to mobile base station apparatus 11 and nearby base station apparatus 41. Both terminal apparatus 16 in another mobile body 51, which can move similarly to mobile body 10 mounted with mobile base station apparatus 11, and terminal apparatus 16, which is not in any of the mobile bodies, can connect to mobile base station apparatus 11. For example, mobile base station apparatus 11 installed to accommodate traffic at an event site or a disaster area is conceivable. Furthermore, such a case is also conceivable in which mobile body 10 is a broadcast-relay vehicle for relaying marathon broadcasts, and mobile body 51 is an escort vehicle accompanying runners.

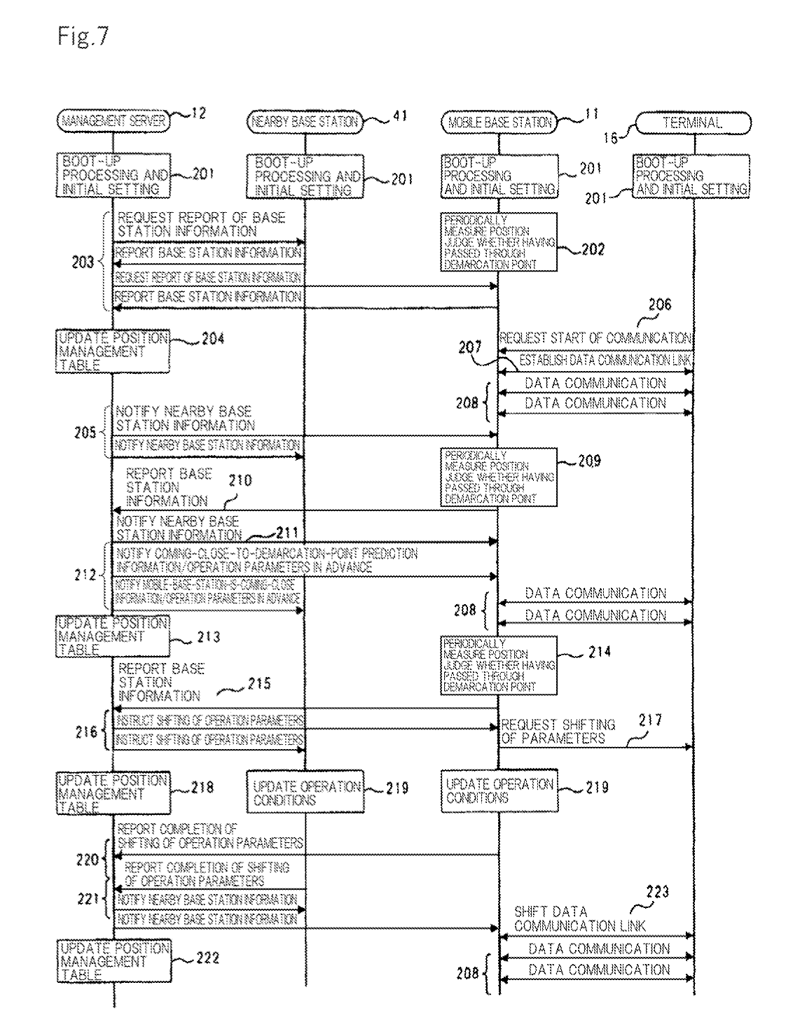

FIG. 7 is a sequence diagram showing an operation example of the wireless communication system of this exemplary embodiment. Here, the wireless communication system is assumed to include nearby base station apparatus 41 in addition to mobile base station apparatus 11 and management server 12.

Referring to FIG. 7, management server 12, nearby base station apparatus 41, mobile base station apparatus 11 and terminal apparatus 16 complete boot-up processing and initial setting (step 201), and the wireless communication system starts normal operation. In the normal operation, mobile base station apparatus 11 periodically measures the position where it is present and judges whether or not it has passed through an area boundary (demarcation point) (step 202).

Management server 12 requests each of the base station apparatuses including nearby base station apparatus 41 and mobile base station apparatus 11 to report base station information. In response to the request, each base station apparatus reports its base station information to management server 12 (step 203). The base station information includes position information indicating the position of the base station apparatus and set operation parameters.

Management server 12 records the position of each base station apparatus to a position management table, and updates the position management table when receiving the report of the base station information (step 204). After updating the position management table, management server 12 notifies each base station apparatus of nearby base station information (step 205). The nearby base station information is information about a nearby base station apparatus and includes, for example, operation parameters used by the nearby base station apparatus. In this example, nearby base station information about nearby base station apparatus 41 is notified to mobile base station apparatus 11, and nearby base station information about mobile base station apparatus 11 is notified to nearby base station apparatus 41.

Terminal apparatus 16 requests mobile base station apparatus 11 to start communication, for example, because the user desires it (step 206). In response to the request, mobile base station apparatus 11 establishes a data communication link between terminal apparatus 16 and network 15 (step 207). Terminal apparatus 16 is enabled to perform data communication due to the establishment of the data communication link (step 208).

Mobile base station apparatus 11 periodically measures its position (step 209) and transmits reports of base station information to management server 12 (step 210). Management server 12 notifies nearby base station information to mobile base station apparatus 11 as needed (step 211).

Management server 12 predicts movement of mobile base station apparatus 11 on the basis of position information included in the base station information notified from mobile base station apparatus 11. When mobile base station apparatus 11 comes close to a demarcation point and it is predicted that mobile base station apparatus 11 will move into a different area passing through the demarcation point, management server 12 notifies each base station apparatus of operation parameters to be used when mobile base station apparatus 11 moves into the area, together with the movement prediction result (step 212). In this case, management server 12 notifies mobile base station apparatus 11 of coming-close-to-demarcation-point prediction information showing that mobile base station apparatus 11 is close to the demarcation point and including a predicted movement destination, and operation parameters to be used when mobile base station apparatus 11 enters the predicted movement destination. Furthermore, management server 12 notifies nearby base station apparatus 41 of mobile-base-station-coming-close information including a prediction result indicating that a near mobile base station apparatus will come close passing through a demarcation point, and operation parameters to be used at nearby base station apparatus 41 when the mobile base station apparatus passes through the demarcation point. Receiving the report of the base station information, management server 12 updates the position management table (step 213).

Receiving the report of the base station information (step 215) including the result of the periodical position measurement at mobile base station apparatus 11 (step 214), management server 12 instructs mobile base station apparatus 11 and nearby base station apparatus 41 to perform shifting to the operation parameters transmitted in advance (step 216) when detecting that mobile base station apparatus 11 has moved to the area as predicted. If there is an operation parameter to be notified to terminal apparatus 16 connected to mobile base station apparatus 11, mobile base station apparatus 11 requests terminal apparatus 16 to perform shifting to the operation parameter (step 217).

Receiving the report of the base station information, management server 12 updates the position management table (step 218). Receiving the instruction to shift the operation parameters, nearby base station apparatus 41 and mobile base station apparatus 11 update the operation parameters used for operation (step 219). Then, when having completed shifting the operation parameters, nearby base station apparatus 41 and mobile base station apparatus 11 report it to management server 12 (step 220).

On the basis of the report of completion of shifting of the operation parameters received from each base station apparatus, management server 12 notifies new nearby base station information to each base station apparatus (step 221) and updates the position management table (step 222).

Mobile base station apparatus 11 shifts the data communication link used by terminal apparatus 16 for data communication to a new data communication link if it is needed as the operation parameters are shifted at mobile base station apparatus 11 (step 223).

Next, description will be made on an example of control information to be transmitted from management server 12 to mobile base station apparatus 11, such as operation parameters, in the wireless communication system of this exemplary embodiment. The control information includes, in addition to information that is simply determined by, an area or position where mobile base station apparatus 11 exists, information that is determined not only by a simple position but also by mobile base station apparatus 11 or its surrounding conditions.

Examples of the parameters dependent on the position of mobile base station apparatus 11 will be shown below.

### (a) Selection of Operation Form of Base Station Itself

This is a parameter indicating the operation form of mobile base station apparatus 11.

Though mobile base station apparatus 11 can be used for various purposes, the operation form of mobile base station apparatus 11 differs according to the purpose. The operation form may differ according to the installation place of mobile base station apparatus 11, such as the inside of a route bus, the inside of a long-distance bus, the inside of a railroad vehicle, the inside of a Shinkansen train, the inside of an airplane, the inside of a ship, a mobile broadcast-relay vehicle (for example, a marathon broadcast-relay vehicle) and the event site of a theme park, a festival, an exhibition or the like. The operation form may differ according to installation purposes, such the addition of an emergency circuit at the time of a disaster and the addition of a temporary circuit in a high-traffic area.

The behavior of mobile base station apparatus 11 performed when it moves differs according to the operation form. For example, in case of predicting movement of mobile base station apparatus 11, prediction accuracy is enhanced by considering at what speed mobile base station apparatus 11 is expected to move, as a parameter.

For example, the selection of the operation form of a base station itself may be a parameter that pays attention to the behavior at the time of movement. Such a setting is possible in which the mobile base station apparatus is made to be a fixed base station after having moved. Such a setting is also possible in which the mobile base station apparatus moves at a low speed (about 10 km/h). Such a setting is also possible in which the mobile base station apparatus moves at a high speed.

### (b) Selection of Backbone System to be Used

Mobile base station apparatus 11 can connect to network 15 by various backbone systems. Mobile base station apparatus 11 may switch the backbone system so that it is connected as it moves. The selection of backbone system to be used is a parameter for setting a backbone system to which mobile base station apparatus 11 is to be connected. By changing the setting of this parameter, the backbone can be switched.

In the example in FIG. 1, a backbone system using a satellite circuit is shown. However, various systems can be used as the backbone system. For example, roaming to a WiMAX fixed station, roaming to a WiMAX mobile station, a communication satellite circuit, a satellite phone circuit, a microwave circuit, a mobile phone circuit, railroad radio, airplane radio, fire-fighting/police radio, a PHS (Personal Handy Phone System) circuit and a WiFi hotspot are included.

### (c) Frequency Band Used

Mobile base station apparatus 11 connects to terminal apparatus 16 using radio waves having a predetermined frequency band. Different frequency bands may be used according to areas. In this case, mobile base station apparatus 11 switches the frequency band according to the position where it is present. Examples of the frequency band used include 2.5 GHz band, 3.5 GHz band and the like in the case of a WiMAX system and 2.4 GHz band, 5 GHz band and the like in the case of a WiFi system.

### (d) Channel Bandwidth Used

Mobile base station apparatus 11 connects to terminal apparatus 16 using a predetermined channel bandwidth. Different channel bandwidths may be used according to areas. In this case, mobile base station apparatus 11 switches the channel bandwidth according to the position where it exists. Examples of the channel bandwidth include 7 MHz bandwidth, 10 MHz bandwidth and the like in the case of a WiMAX system and 5 MHz bandwidth, 10 MHz bandwidth and the like in the case of a WiFi system.

(e) Frequency Channel Used/Frequency Channel Changed Mobile base station apparatus 11 may change the channel number or the center frequency for connecting to terminal apparatus 16 as it moves. In this case, the value can be changed depending on nearby base station apparatus 41 as mobile base station apparatus 11 moves.

### (f) Modulation Method Used/Coding Rate

Mobile base station apparatus 11 may change the combination of a coding method and an error correction coding rate for connecting to terminal apparatus 16 as it moves. Examples of the combination of a coding method and an error correction coding rate include BPSK-1/2, QPSK-3/4 and 16QAM-3/4 in the case of a WiMAX system.

### (g) Transmission Output Power Used and Dynamic Range

Mobile base station apparatus 11 may change the transmission output power or the dynamic range used for transmission of a signal to terminal apparatus 16 as it moves. For example, it is possible to set the dynamic range of a variable range of transmission output as +20 to 40 dBm and specify transmission output at stages in units of dBs. In an area where other base station apparatuses are congested around mobile base station apparatus 11, connection can be secured by decreasing the transmission output and decreasing the throughput to suppress interference with nearby base station apparatus 41.

### (h) Selection of Antenna

Mobile base station apparatus 11 may switch the antenna to be used as the area changes. Mobile base station apparatus 11 may also switch the antenna direction as it moves. For example, the communication direction may be narrowed by switching from an omni-directional antenna to a sector antenna or switching between sector antennas having different gains or different directional characteristics.

### (i) Nearby Base Station Information

Mobile base station apparatus 11 may autonomously control the operation parameters according to the conditions of nearby base stations which change as mobile base station apparatus 11 moves. For example, mobile base station apparatus 11 may determine operation parameters to be used at the base station when receiving notification of operation parameters used at nearby base station apparatus 41. Examples of the operation parameters of nearby base station apparatus 41 to be notified include (c) to (g) described above.

### (j) Nearby-Base-Station-Coming-Close Information

Mobile base station apparatus 11 may autonomously control the operation parameters according to a nearby base station which comes close as mobile base station apparatus 11 moves. For example, in a track-mode for tracing a predetermined track or in a moving-on-route mode for tracing a predetermined route, mobile base station apparatus 11 can assume that it comes close to a nearby base station and can estimate the time of coming close thereto from the position of the near fixed base station or mobile base station or the speed thereof.

### (k) Surrounding Traffic Conditions

Mobile base station apparatus 11 may autonomously control the operation parameters according to a change in the traffic conditions of a nearby base station accompanying movement of mobile base station apparatus 11. Mobile base station apparatus 11 may switch the operation parameters on the basis of its own traffic conditions and the traffic conditions of nearby base station apparatus 41.

### (l) Management of Terminal/Classification of Accounting/Classification of QoS Control

The account method may be changed due to a change in operation accompanying movement of mobile base station apparatus 11. For example, due to switching of the backbone circuit, the communication band class is changed, and the throughput and the accounting method may be changed. There is a QoS setting in which best-effort or certain-band-ensured is to be set as a communication band class. When a parameter used by terminal apparatus 16 is changed, the parameter can be notified to terminal apparatus 16 from management server 12 via mobile base station apparatus 11.

### (m) Speed Information

Management server 12 may simply calculate movement speed from the history of results of position measurement of mobile base station apparatus 11 and notify mobile base station apparatus 11 of it. Mobile base station apparatus 11 may determine the timing of switching the operation parameters using the notified movement speed.

### (n) Broadcast Information

It is also possible to install a dedicated application for receiving a broadcast notification in terminal apparatuses 16 in advance and notify event information as a broadcast notification according to areas. Examples of the broadcast notification include a prefectural border crossing notification on the basis of position measurement information, a local event notification, delivery of an animation explaining an attraction in a theme park, delivery of an emergency announcement of an earthquake, notification of surrounding traffic conditions and the like.

Next, description will be made on an example of a case where management server 12 determines control information according to the conditions, such as selection of operation parameters. In addition to control information which is determined simply by an area or a position where mobile base station apparatus 11 is present (operation parameters and the like), there is control information which is determined according to a change in the surrounding conditions and the like accompanying movement.

(a) A situation is assumed in which the inside of mobile body 10 mounted with mobile base station apparatus 11 is an electromagnetically shielded space, and the door is opened when mobile body 10 is present at a certain place. It is assumed that mobile base station apparatus 11 connects only to terminal apparatus 16 in mobile body 10 when the door is closed and it also connects to terminal apparatus 16 outside mobile body 10 when the door is open. In this case, the transmission output power of mobile base station apparatus 11 may be controlled according to the position of mobile base station apparatus 11.

(b) When mobile base station apparatus 11 enters a certain area, terminal apparatus 16 connected to mobile base station apparatus 11 is enabled to perform handover or roaming to another base station apparatus that is present in the area. If mobile base station apparatus 11 and that another base station apparatus are operated by the same carrier, handover is possible. If they are operated by different carriers, roaming is possible. In this case, it may be notified from management server 12 to mobile base station apparatus 11 that handover or roaming is possible.

Similarly, when mobile base station apparatus 11 leaves a certain area, terminal apparatus 16 performing handover or roaming to another base station apparatus can be reconnected to mobile base station apparatus 11.

(c) If mobile body 10 mounted with mobile base station apparatus 11 does not have an electromagnetic wave shielding function, mobile base station apparatus 11 may be required to control output according to the position where it is present. For example, it is conceivable to decrease the output power so as not to affect nearby base station apparatus 41 or to change the frequency channel to a frequency channel which is not used by nearby base station apparatus 41.

(d) When mobile base station apparatus 11 moves and enters an area of a fixed hotspot, the backbone circuit may be switched from a low-speed circuit to a high speed communication circuit via a nearby fixed base station apparatus. For example, in the case where a railroad vehicle stops at a station, mobile base station apparatus 11 mounted on the railroad vehicle may be connected to a fixed base station apparatus installed on the road side to temporarily switch the backbone to high speed communication using local fixed communication.

(e) Management server 12 may control the operation parameters of mobile base station apparatus 11 according to the conditions of a nearby base station which changes as mobile base station apparatus 11 moves. For example, management server 12 may determine operation parameters to be used at mobile base station apparatus 11 when receiving notification of operation parameters used at nearby base station apparatus 41.

(f) Management server 12 may control mobile base station apparatus 11 according to a nearby base station coming close to mobile base station apparatus 11. For example, if mobile base station apparatus 11 is moving in a track-mode for tracing a predetermined track or in a moving-on-route mode for tracing a predetermined route, management server 12 can assume that mobile base station apparatus 11 comes close to a nearby base station and can estimate the time of coming close thereto from the position or speed of the nearby fixed base station or mobile base station.

(g) Management server 12 may control mobile base station apparatus 11 according to a change in the traffic conditions of a nearby base station around mobile base station apparatus 11. Each of the base station apparatuses including mobile base station apparatus 11 and fixed base station apparatuses can report its traffic conditions to management server 12, and management server 12 can control each base station apparatus according to the traffic congestion conditions and interference conditions around each base station apparatus.

Management server 12 may collectively manage various information about all base station apparatuses under its control (including mobile base station apparatus 11 and fixed base station apparatuses) with a management table and comprehensively judge and determine information to be set for each base station apparatus from the whole management table. For example, management server 12 appropriately may updates the various information items in the management table and notify each base station apparatus of part of the information as control information.

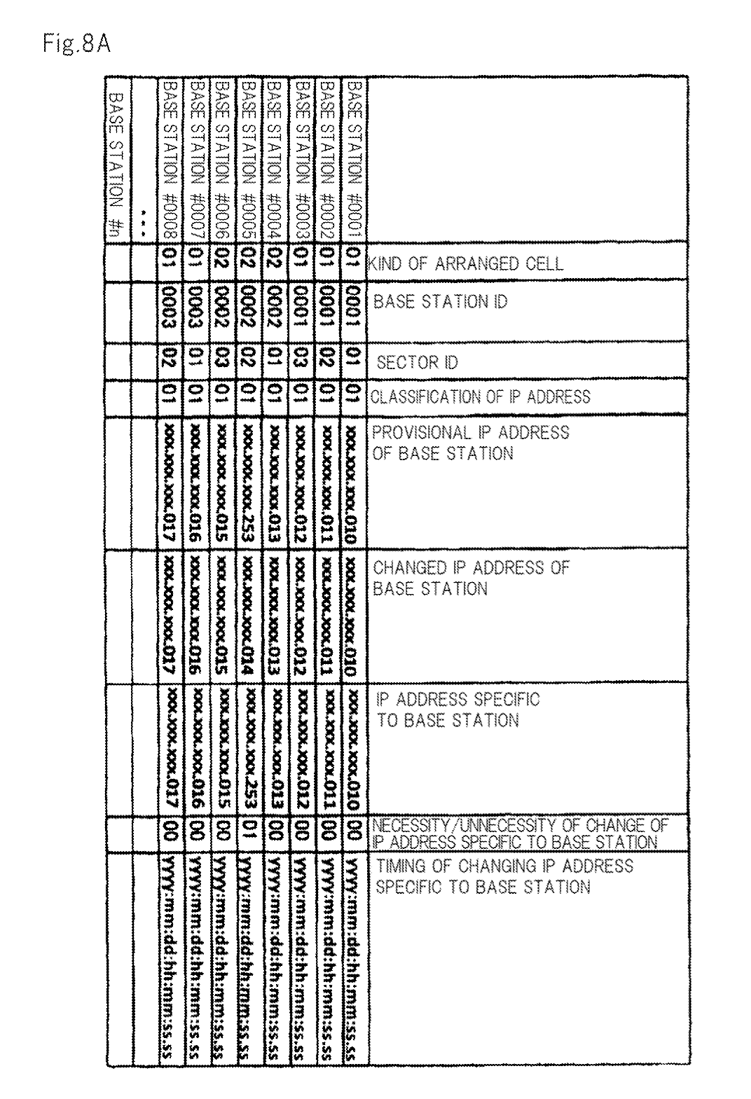

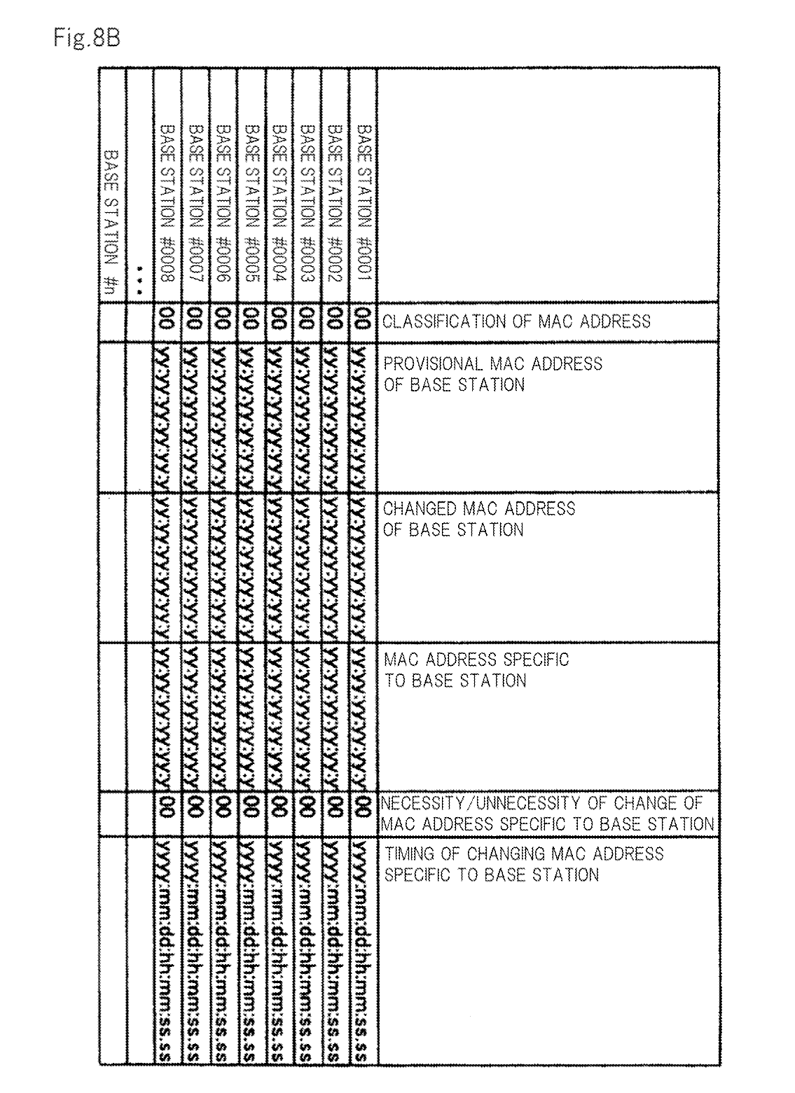

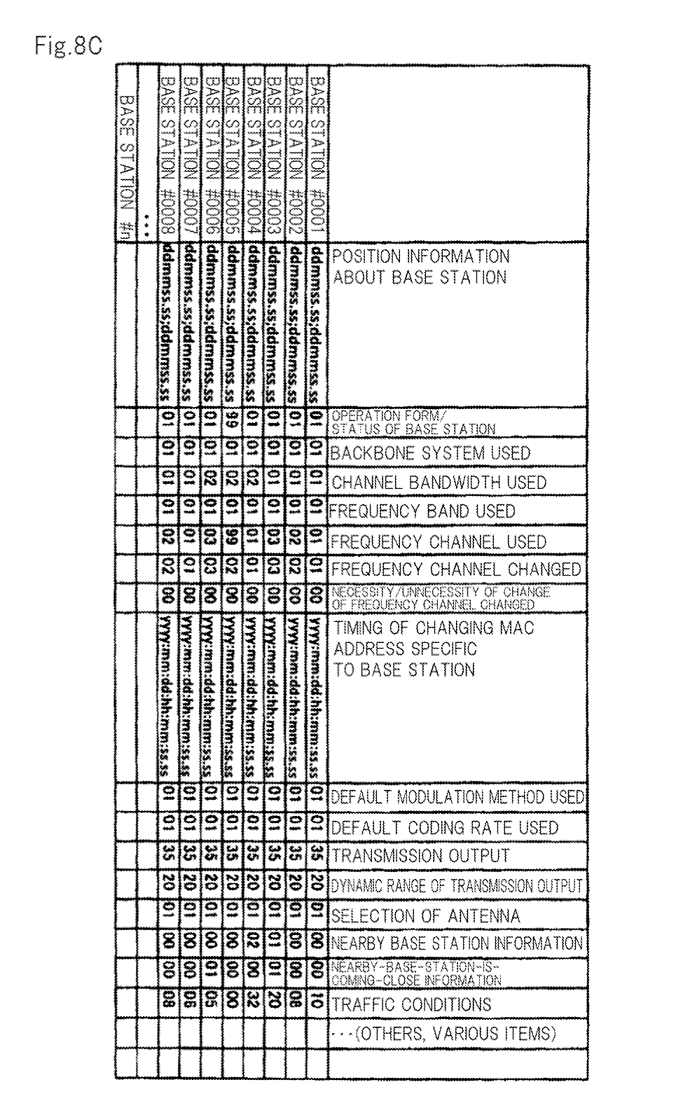

FIGS. 8A to 8C are diagrams showing an example of the management table on management server 12. Though the divided three tables of FIGS. 8A to 8C are shown here, management server 12 may hold these as one table or may hold each of them. In the management table, various items of information about each base station apparatus are recorded in association with each base station apparatus. The information includes fixed parameters which are seldom changed after they are once set, parameters adjusted according to the conditions during operation, parameters changed gradually as the base station apparatus moves and, furthermore, parameters changed gradually as a nearby base station apparatus moves, and the like.

For example, a base station ID and a sector ID are seldom changed after they are once set, but a backbone system to be used may be changed according to the position of the base station apparatus. The nearby base station information may be changed not only by the position of the base station apparatus but also by the position of and information about another base station apparatus. As for the channel bandwidth used, the frequency band used, the frequency channel used, the transmission output, the dynamic range of transmission output, the selection of antenna and the like, it is preferable to control them to be suitable values on the basis of mutual relationship between the cell of the base station apparatus and the cell of a nearby base station apparatus.

In the example of a moving network, a fixed base station apparatus to which mobile base station apparatus 11 is connected is switched as mobile base station apparatus 11 moves. If the traffic conditions differ for each of the cells of fixed base station apparatuses, management server 12 may change the parameters of mobile base station apparatus 11 according to position information. Thereby, in the moving network, management server 12 can select suitable values according to the traffic conditions of a fixed base station apparatus as the parameters of mobile base station apparatus 11.

In the example of the moving network, management server 12 may further predict future movement of mobile base station apparatus 11, and notify mobile base station apparatus 11 of the parameters of mobile base station apparatus 11 at a movement destination or notify a fixed base station apparatus predicted to be the next connection destination of mobile base station apparatus 11 of the parameters in advance. Thereby, even if mobile base station apparatus 11 moves at a high speed, it is possible to quickly follow the movement and control the operation of mobile base station apparatus 11 or the fixed base station apparatus.

Exemplary embodiments have been described. However, the present invention is not limited thereto, and the embodiments may be combined and used or a part of the configuration may be changed within the scope of the technical idea of the present invention.

The present invention has been described with reference to the exemplary embodiment. However, the present invention is not limited to the exemplary embodiment. In the configuration and details of the present invention defined in the claims, various modifications understandable to one skilled in the art can be made within the scope of the present invention.

This application claims the benefit of priority based on Japanese Patent Application No. 2008-186147 filed on Jul. 17, 2008, the disclosure of which is hereby incorporated by reference thereto in its entirety.

1. A wireless communication system comprising:
a mobile base station apparatus connecting to a terminal apparatus and being movable; and
a management server performing centralized control of the mobile base station apparatus; wherein
the mobile base station apparatus measures its position and notifies the management server of position information indicating the position;
the management server transmits control information according to the position information notified from the mobile base station apparatus, to the mobile base station apparatus; and
the mobile base station apparatus operates using the control information received from the management server.

2. The wireless communication system according to claim 1, wherein the mobile base station apparatus connects to a terminal apparatus which moves together with the mobile base station apparatus.

3. The wireless communication system according to claim 1, wherein the management server predicts future movement of the mobile base station apparatus from a, history of the position information notified from the mobile base station apparatus and transmits control information according to the predicted movement destination to the mobile base station apparatus.

4. The wireless communication system according to claim 3, wherein
after transmitting the control information according to the predicted movement destination to the mobile base station apparatus, the management server instructs the mobile base station apparatus to apply the control information when the mobile base station apparatus moves to the movement destination; and
when receiving the control information from the management server, the mobile base station apparatus holds the control information, and applies the control information when being instructed by the management server.

5. The wireless communication system according to claim 3, wherein
the management server transmits the control information according to the predicted movement destination to the mobile base station apparatus together with movement destination information indicating the movement destination; and
the mobile base station apparatus receives the control information and the movement destination information from the management server, and starts using the control information when the mobile base station apparatus moves to the movement destination shown in the movement destination information.

6. The wireless communication system according to claim 3, wherein the management server holds track information indicating the track of the mobile base station apparatus in advance and predicts movement of the mobile base station apparatus using the track information.

7. The wireless communication system according to claim 1, wherein the control information is operation parameters specifying the operation of the mobile base station apparatus.

8. The wireless communication system according to claim 1, wherein the management server further transmits control information according to the position information notified from the mobile base station apparatus, to a base station apparatus around the mobile base station apparatus.

9. The wireless communication system according to claim 1, wherein the management server determines the control information to be transmitted to the mobile base station apparatus on the basis of the position and movement speed of the mobile base station apparatus.

10. A management server comprising:
a base station position management section that obtains position information indicating the position of a mobile base station apparatus connecting to a terminal apparatus and being movable, from the mobile base station apparatus; and
a base station control section that for transmits control information according to the position information managed by the base station position management section, to the mobile base station apparatus.

11. The management server according to claim 10, wherein the base station control section predicts future movement of the mobile base station apparatus from a history of the position information obtained by the base station position management section and transmits control information according to a predicted movement destination to the mobile base station apparatus.

12. A mobile base station apparatus connecting to a terminal apparatus and being movable, the mobile base station apparatus comprising:
a position measurement section that measures the position of the mobile base station apparatus;
a notification section that notifies a management server of position information indicating the position measured by the position measurement section; and
an operation control section means that operates by using control information according to the position information, which is received from the management server.

13. The mobile base station apparatus according to claim 12 connecting to a terminal apparatus which moves together with the mobile base station apparatus.

14. The mobile base station apparatus according to claim 12, wherein
control information according to a movement destination of the mobile base station apparatus which is predicted from a history of the position information notified by the notification section is transmitted from the management server to the mobile base station apparatus, and furthermore, application of the control information is instructed when the mobile base station apparatus moves to the movement destination; and
when receiving the control information from the management server, the operation control section holds the control information, and applies the control information when being instructed by the management server.

15. The mobile base station apparatus according to claim 12, wherein
control information according to a movement destination of the mobile base station apparatus which is predicted from a history of the position information notified by the notification section is transmitted from the management server to the mobile base station apparatus together with movement destination, information indicating the movement destination; and
the operation control section receives the control information and the movement destination information from the management server, and starts using the control information when the mobile base station apparatus moves to the movement destination shown in the movement destination information.

16. The mobile base station apparatus according to claim 12, wherein the control information is operation parameters specifying the operation of the mobile base station apparatus.

17. (canceled)
